(19) United States
(12) Patent Application Publication
(10) Pub. No.: US 2025/0391993 A1
(43) Pub. Date: Dec. 25, 2025

(54) FLAME ARRESTOR FOR BATTERY CELL GROUP ASSEMBLY

(71) Applicant: GM Global Technology Operations LLC, Detroit, MI (US)

(72) Inventors: Anne Zhang, Troy, MI (US); Nicholas P. Irish, Keego Harbor, MI (US); Brian J. Koch, Berkley, MI (US); Jing Gao, Rochester, MI (US); Mark Daniel Gottlieb, Royal Oak, MI (US); Sobana Perumaram Rangarajan, Hazel Park, MI (US); Louis G. Hector, JR., Shelby Twp., MI (US)

(73) Assignee: GM Global Technology Operations LLC, Detroit, MI (US)

(21) Appl. No.: 18/749,272

(22) Filed: Jun. 20, 2024

(51) Int. Cl. H01M 50/383; H01M 10/613; H01M 10/625; H01M 10/658; H01M 50/249

(52) U.S. Cl. CPC H01M 50/383; H01M 10/613; H01M 10/625; H01M 10/658; H01M 50/249; H01M 2220/20

(57) ABSTRACT

A battery cell group assembly for a vehicle includes a housing including a plurality of panels defining a cavity and one or more battery cells disposed within the cavity of the housing. One or more thermal barriers are coupled to each of the one or more battery cells, and vents are defined proximate to the one or more battery cells. The battery cell group assembly also includes at least one flame arrestor disposed over the vents. The at least one flame arrestor has a thermally conductive surface area and includes a first set of openings. The first set of openings are configured to redirect heat from the one or more battery cells within the cavity of the housing. The battery cell group assembly further includes a thermal mass that is thermally coupled to the at least one flame arrestor.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a flame arrestor for a cell group assembly of a vehicle.

Vehicles may be equipped with battery cell packs that are grouped within a shell configured with vents. The vents are designed to prevent condensation and potential corrosion of the battery cells. In the event of a thermal runaway event, however, the vents provide open access for flaming gasses to pass through the vents and spread to one or more neighboring battery cells. While the vents advantageously assist in preventing corrosion, there is a need to improve the vents to minimize the potential of propagating a thermal runaway event.

### SUMMARY

In some aspects, a battery cell group assembly for a vehicle includes a housing including a plurality of panels defining a cavity and one or more battery cells disposed within the cavity of the housing. One or more thermal barriers are coupled to each of the one or more battery cells, and vents are defined proximate to the one or more battery cells. The battery cell group assembly also includes at least one flame arrestor disposed over the vents. The at least one flame arrestor has a thermally conductive surface area and includes a first set of openings. The first set of openings are configured to redirect heat from the one or more battery cells within the cavity of the housing. The battery cell group assembly further includes a thermal mass that is thermally coupled to the at least one flame arrestor.

In some examples, the at least one flame arrestor may include a mesh panel that includes an endothermic flame retardant material. Optionally, the thermal mass may be a cooling system and the at least one flame arrestor may be integrally formed with the cooling system. In some configurations, the vents may be defined by the battery cells and the at least one flame arrestor may be integrally formed with each battery cell at a respective vent. In further instances, the vents may be defined by the battery cells and the at least one flame arrestor may be integrally formed with a top panel of the plurality of panels of the housing.

In other examples, the battery cells may include particulate matter and the mesh panel of the at least one flame arrestor may be configured to trap the particulate matter within the cavity of the housing. Optionally, the mesh panel may include a first mesh and a second mesh. The first mesh may include the first set of openings. In some instances, the first set of openings may be smaller than a second set of openings of the second mesh.

In other aspects, a battery cell group assembly includes a housing including a plurality of panels defining a cavity and one or more battery cells disposed within the cavity of the housing. Vents are defined proximate to the one or more battery cells, and at least one flame arrestor is disposed over the vents. The at least one flame arrestor has a thermally conductive surface area and includes a mesh panel. The mesh panel includes a first set of openings that are configured to redirect heat from the one or more battery cells within the cavity of the housing. The battery cell group assembly also includes a thermal mass that is thermally coupled to the at least one flame arrestor.

In some examples, the mesh panel of the at least one flame arrestor may include an endothermic flame retardant material. Optionally, the thermal mass may be a cooling system and the at least one flame arrestor may be integrally formed with the cooling system. In some instances, the vents may be defined by the battery cells and the at least one flame arrestor may be integrally formed with each battery cell at a respective vent. In other configurations, the vents may be defined by the battery cells and the at least one flame arrestor may be integrally formed with a top panel of the plurality of panels of the housing.

In other examples, the battery cells may include particulate matter and the mesh panel of the at least one flame arrestor may be configured to trap the particulate matter within the cavity of the housing. Optionally, the mesh panel may include a first mesh and a second mesh. The first mesh may include the first set of openings. In some instances, the first set of openings may be smaller than a second set of openings of the second mesh.

In further aspects, a battery cell group assembly for a vehicle includes a housing including a plurality of panels defining a cavity and one or more battery cells disposed within the cavity of the housing. Vents are defined proximate to the one or more battery cells, and at least one flame arrestor is disposed over the vents. The at least one flame arrestor has a thermally conductive surface area and includes a mesh panel. The mesh panel includes a first set of openings configured to redirect heat from the one or more battery cells within the cavity of the housing. The mesh panel also includes an endothermic flame retardant material. The battery cell group assembly also includes a thermal mass that is thermally coupled to the at least one flame arrestor.

In some examples, the thermal mass may be a cooling system and the at least one flame arrestor may be integrally formed with the cooling system. Optionally, the vents may be defined by the battery cells and the at least one flame arrestor may be integrally formed with each battery cell at a respective vent. In some instances, the vents may be defined by the battery cells and the at least one flame arrestor may be integrally formed with a top panel of the plurality of panels of the housing. In some configurations, the battery cells may include particulate matter and the mesh panel of the at least one flame arrestor may be configured to trap the particulate matter within the cavity of the housing. Optionally, the mesh panel may include a first mesh and a second mesh. The first mesh may include the first set of openings, and the first set of openings may be smaller than a second set of openings of the second mesh.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle configured with a battery cell group assembly according to the present disclosure;

FIG. 2 is a top perspective view of a battery cell group assembly according to the present disclosure;

FIG. 3 is an exploded side perspective view of the battery cell group assembly of FIG. 2;

FIG. 4 is a cross-sectional view of a mesh panel of a flame arrestor according to the present disclosure;

FIG. 5 is an exploded side perspective view of another battery cell group assembly according to the present disclosure;

FIG. 6 is an exploded side perspective view of a further battery cell group assembly according to the present disclosure;

FIG. 7 is a top perspective view of another battery cell group assembly according to the present disclosure; and

FIG. 8 is an exploded side perspective view of the battery cell group assembly of FIG. 7.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated within, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

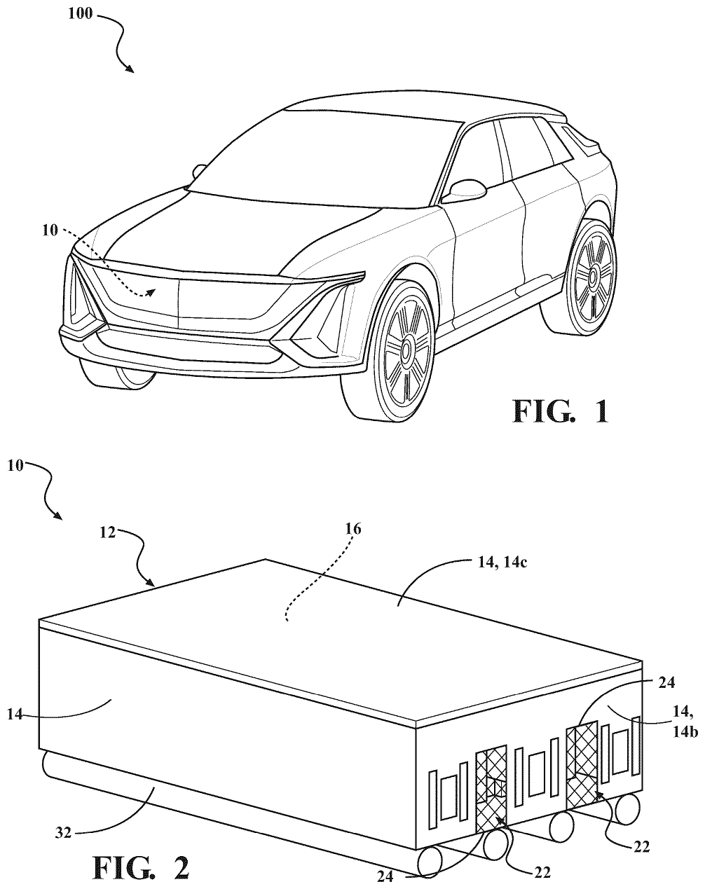

Referring to FIGS. 1-4, a battery cell group assembly 10 of a vehicle 100 includes a housing 12 that includes a plurality of panels 14 defining a cavity 16. One or more battery cells 18 are disposed within the cavity 16 of the housing 12 and are configured to at least partially power the vehicle 100. The battery cells 18 are grouped within the housing 12 and are separated by one or more thermal barriers 20 coupled to each of the battery cells 18. The thermal barriers 20 are configured with a low thermal conductivity. In some examples, the thermal barriers 20 may be disposed between and may be uncoupled from the battery cells 18. The thermal barriers 20 assist in minimizing the potential of a thermal runaway event occurring between the battery cells 18 by minimizing thermal contact between each of the battery cells 18. During operation, the battery cells 18 generate heat and, in some instances, gasses, which may accumulate within the housing 12. Thus, vents 22 are defined at the housing 12 to expel the hot gasses through a flame arrestor 24, described below. For example, if one group of battery cells 18 experiences overheating or is otherwise compromised by heat to the point of flame generation, the flame arrestor 24 is configured to trap and prevent movement of the heat and/or potential flames between battery cells 18.

Each vent 22 illustrated in FIG. 2 is covered by a flame arrestor 24, which is configured to dissipate the hot gasses that may be generated by the battery cells 18. For example, the hot gasses expelled through the vent 22 are dissipated by the flame arrestor 24. The flame arrestor 24 has a thermally conductive surface area 26, which absorbs and neutralizes the heat of the gasses, and also includes a mesh panel 28. The mesh panel 28 includes a first set of openings 30 configured to redirect heat from the battery cells 18 within the cavity 16 of the housing 12. Further, a thermal mass 32 is thermally coupled to the flame arrestor 24 and is configured to receive diverted heat and heated gasses from the flame arrestor 24, described below.

In some configurations, the thermal mass 32 may be a cooling system 32a that is coupled to a bottom panel 14a of the plurality of panels 14. In some instances, the flame arrestor 24 may be integrally formed with the cooling system 32a, such that each of the bottom panel 14a, the cooling system 32a, and the flame arrestor 24 are integrally formed. In other examples, the flame arrestor 24 may be integrally formed with the bottom panel 14a and subsequently coupled with the thermal mass 32. The thermal mass 32 may also include, but is not limited to, a heat sink. The thermal mass 32 is configured to receive redirected heat from the housing 12 generated by the battery cells 18 via the flame arrestor 24.

Referring still to FIGS. 1-4, the flame arrestor 24 allows heat and heated gasses to pass through the mesh panel 28 and transfers the heat across the thermally conductive surface area 26 to the thermal mass 32, described below. Thus, the thermal mass 32 cooperates in combination with the flame arrestor 24 to divert heat from a potential thermal runaway of the battery cell group assembly 10. The thermal mass 32 may be utilized in various configurations of the flame arrestor 24 described herein, but is generally illustrated in a first configuration of the battery cell group assembly 10 with the flame arrestor 24 being integrally formed with the bottom panel 14a. As a result of the direct coupling between the bottom panel 14a and the thermal mass 32, the bottom panel 14a may be referred to, in some examples, as a cooling panel. 4a.

With further reference to FIGS. 2-4, the flame arrestor 24 and the cooling panel 14a may be stamped or formed from one piece of sheet material and integrated with the thermal mass 32. The flame arrestor 24 may be stamped from the same sheet of material as the cooling panel 14a and subsequently modified to define the thermally conductive surface area 26 and to include the mesh panel 28. In some instances, the mesh panel 28 may be defined by laser cutting the flame arrestor 24 after stamping. The flame arrestor 24 may also be bent or otherwise adjusted relative to the cooling panel 14a, such that the flame arrestor 24 may be normal with and/or perpendicular to the cooling panel 14a.

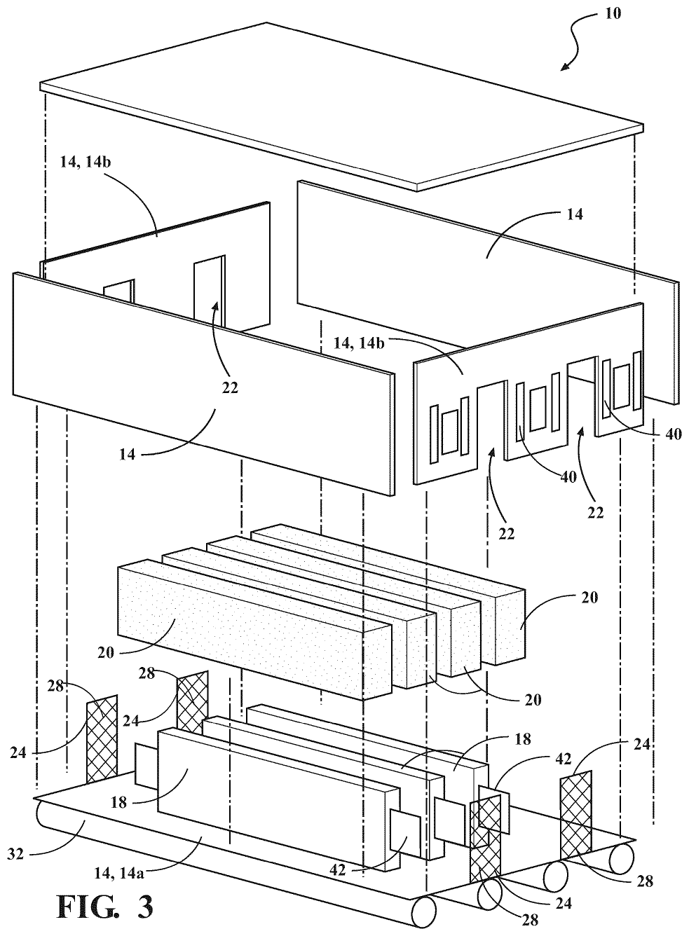

The flame arrestor 24 is joined to the vents 22 to cover the vents 22, while also in thermal contact with the thermal mass 32. The thermal mass 32 is configured to assist in maintaining a cool temperature of the flame arrestor 24 during use of the battery cell group assembly 10. For example, the thermal mass 32 may assist in cooling the flame arrestor 24, via the cooling panel 14a, as hot gasses pass through the flame arrestor 24 covering the vents 22. The vents 22 may be defined in face or end panels 14b of the plurality of panels 14. In other configurations, described below, the vents 22 may be defined in a top panel 14c of the plurality of panels 14. The vents 22 are defined proximate to the battery cells 18 and are configured to facilitate air circulation within the cavity 16 of the housing 12 and mitigate condensation within the cavity 16. As illustrated in FIG. 3, the face panel(s) 14b may define slots 40 through which a tab 42 of the battery cells 18 may extend. The slots 40 may be proximate to the vents 22 and may be sealed by the tabs 42. For example, the tabs 42 may generally block substantial airflow between an external environment and the cavity 16 of the housing 12 at the slots 40, such that the airflow is primarily directed through the vents 22. For example, the path of least resistance for the airflow and the hot gasses from the battery cells 18 is through the vents 22 and the flame arrestor 24.

As illustrated in FIG. 2, the flame arrestor 24 is disposed over and covers the vents 22 at the face panel 14b. The mesh panel 28 of the flame arrestor 24 facilitates airflow between the external environment and the cavity 16 to promote cooling and prevent condensation build-up within the cavity, while the thermally conductive surface area 26 of the flame arrestor 24 is configured to divert heat generated by the battery cells 18. Thus, the vents 22 and the flame arrestor 24 cooperate to control condensation and mitigate corrosion of the tabs 42 of the battery cells 18, while the flame arrestor 24 advantageously directs and mitigates the heat generated by the battery cells 18 via the thermally conductive surface area 26.

With further reference to FIGS. 2-4, the mesh panel 28 may include an endothermic flame retardant material 44. For example, the endothermic flame retardant material 44 may include, but is not limited to, magnesium hydroxide and calcium sulfate. The endothermic flame retardant material 44 may be bonded to the mesh panel 28. In some configurations, the mesh panel 28 may be bonded with the endothermic flame retardant material 44.

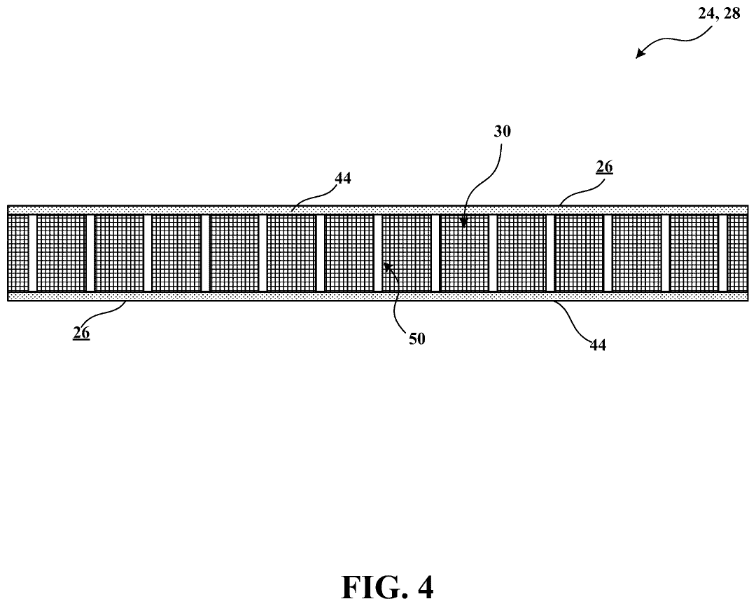

The mesh panel 28 may define the first set of the openings 30 and a second set of openings 50 extending through the mesh panel 28. The second set of openings 50 are configured to direct airflow from within the cavity 16 of the housing 12 toward an external environment. As generally illustrated in FIG. 4, the first set of openings 30 may be smaller than the second set of openings 50. For example, the battery cells 18 may eject particulate matter, and the smaller first set of openings 30 are configured to prevent the ejected particulate matter from escaping the housing 12 and entering an engine system of the vehicle 100 (FIG. 1). The second set of openings are configured to remain open, such that potential particulate matter that may be captured by the mesh panel 28 may at least partially obstruct the first set of openings 30. The second set of openings 50, thus, maintain the airflow between the cavity 16 and the external environment. It is contemplated that the openings 30, 50 may have any practicable configuration and shape to catch ejected particulate matter, while maintaining airflow, such that the configuration illustrated is one exemplary shape and configuration. Thus, the mesh panel 28 traps the particulate matter within the cavity 16 of the housing 12. The second set of openings 50 are configured to direct the airflow between the external environment and the cavity 16. For example, the second set of openings 50 are configured to be larger than the first set of openings 30 to facilitate the movement of the hot gasses.

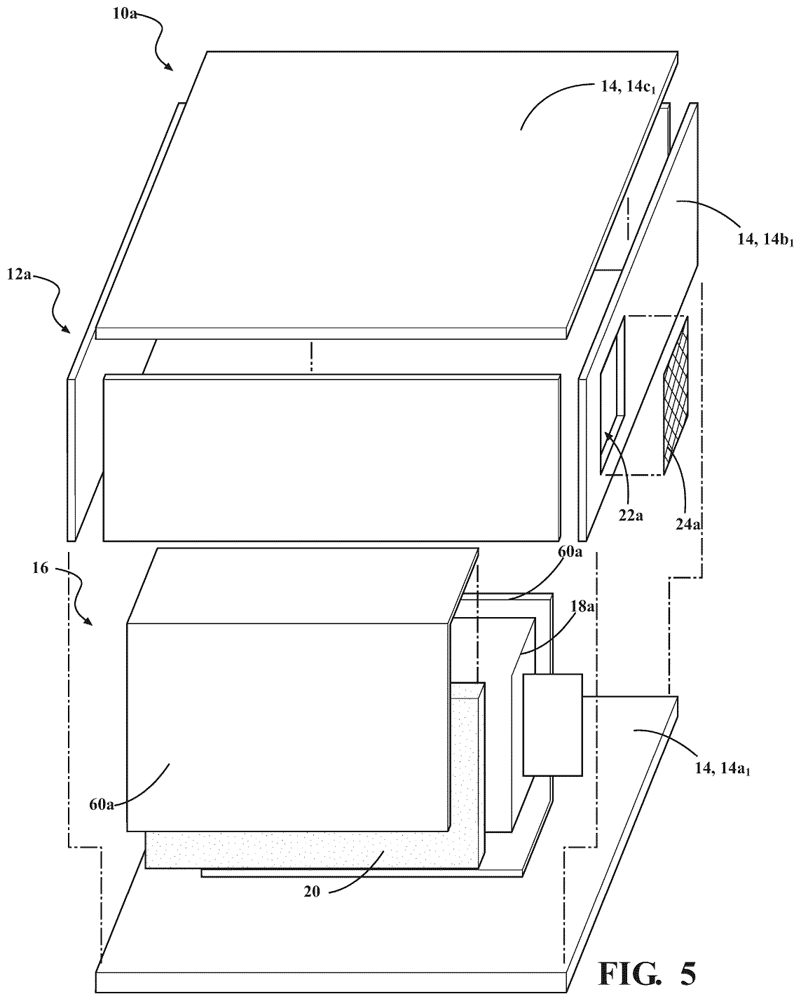

Referring to FIGS. 5-8, other examples of the battery cell group assembly 10a-10c incorporating the principles of the present disclosure are provided. In view of the substantial similarity in structure and function of the components associated with the battery cell group assembly 10a-10c with respect to the battery cell group assembly 10, like reference numerals are used hereinafter and in the drawings to identify like components while like reference numerals containing letter and/or number extensions are used to identify those components that have been modified. While the structure and orientation of the flame arrestor 24a-24c may be modified in each of the battery cell group assemblies 10a-10c, the overall function of the flame arrestors 24a-24c is maintained with respect to the flame arrestor 24 described above.

With reference to FIG. 5, a battery cell group assembly 10a includes a housing 12a that includes a plurality of panels 14. A battery cell 18a is disposed within a cavity 16 of the housing 12a and is encased by an isolator 60a and a thermal barrier 20. The battery group assembly 10a is illustrated in FIG. 5 with a single battery cell 18a, but may be configured with one or more battery cells 18a. A vent 22a is defined at a face panel 14b1 of the plurality of panels 14 of the housing 12a, and a flame arrestor 24a is disposed over the vent 22a. The face panel 14b1 is coupled to a bottom panel 14a1 that is configured as a heat sink of the battery cell group assembly 10a. For example, a thermal mass 32 (FIG. 2) of the battery cell group assembly 10a may correspond with the bottom panel 14a1. The bottom panel 14a1 may be coupled to a cooling system 32 (FIG. 2) to facilitate the diversion of heat generated by the battery cell 18a.

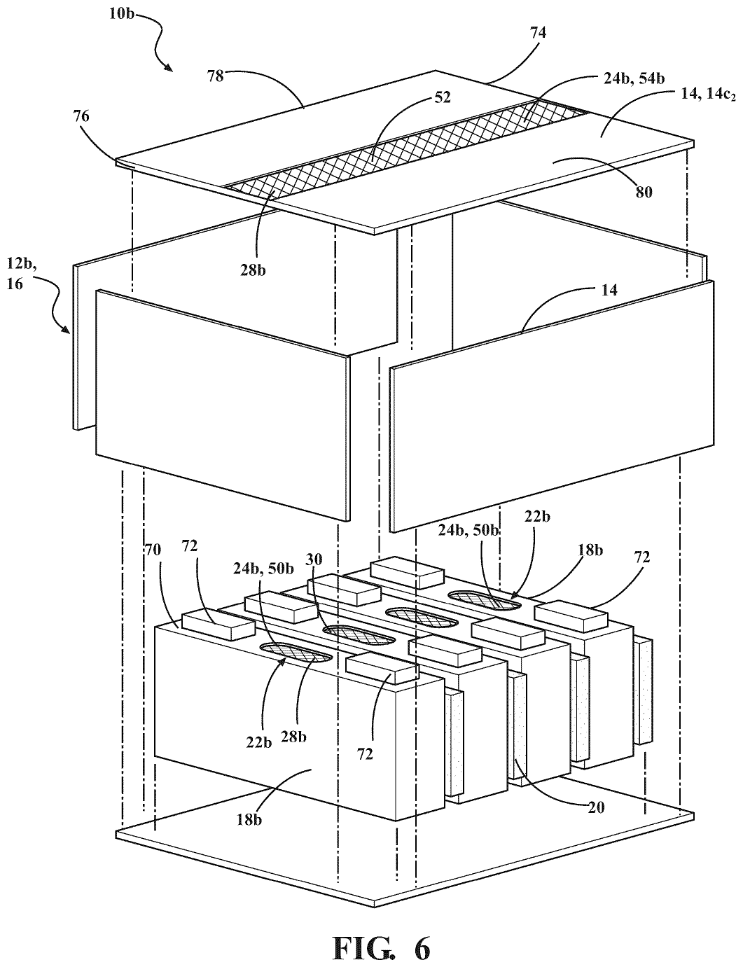

With reference to FIG. 6, a battery cell group assembly 10b includes a housing 12b that includes a plurality of panels 14 and battery cells 18b stored within a cavity 16 of the housing 12b. The battery cells 18b are separated by thermal barriers 20 and each defines a vent 22b along a first surface 70 of the battery cell 18b. The first surface 70 also includes charge contacts 72 on opposing ends of the first surface 70. The vents 22b may be defined between the charge contacts 72 along the first surface 70. The battery cells 18b are disposed within the housing 12, and a top panel 14c2 of the plurality of panels 14 may be disposed on the charge contacts 72. In other configurations, the top panel 14c2 may be disposed on sidewalls of the plurality of panels 14 and spaced apart from the charge contacts 72.

The top panel 14c2 may also define a vent 22b that extends between a first end 74 and a second end 76 of the top panel 14c2. The vents 22b defined by the battery cells 18b and the top panel 14c2 may each include a flame arrestor 24b disposed within and/or covering the respective vent 22b. For example, the vents 22b defined by the battery cells 18b may receive the flame arrestor 24b, such that the flame arrestor 24b may be integrally formed with each battery cell 18b at a respective vent 22b. The flame arrestor 24b may include a mesh panel 28b that may include a first mesh 52b and a second mesh 54b. The first mesh 52b may define a first set of the openings 30, and the second mesh 54b may define a second set of openings 50 (FIG. 4).

Referring still to FIG. 6, as illustrated, the first mesh 52b may be disposed within the vents 22b defined by the battery cells 18b. The first set of openings 30 of the first mesh 52b may be smaller than the second set of openings 50 of the second mesh 54b, such that the second mesh 54b at the top panel 14c1 may facilitate airflow. The first set of openings 30, being smaller than the second set of openings 50, are configured to capture or otherwise block particulate matter that may be ejected by the battery cells 18b. Thus, the smaller first set of openings 30 are configured to prevent the ejected particulate matter from escaping the housing 12b. The first mesh 52b and the second mesh 54b cooperate to define the flame arrestor 24b, as the second mesh 54b is generally disposed over the first mesh 52b.

The second mesh 54b extends between the first end 74 and the second end 76 of the top panel 14c2 along the vent 22b defined by the top panel 14c2. The top panel 14c2 may thus be divided into a first side 78 and a second side 80 by the vent 22b and the flame arrestor 24b. The first side 78 may be positioned on one of a positive charge contact 72 and a negative charge contact 72, and the second side 80 may be positioned on the other of the positive charge contact 72 and the negative charge contact 72. The second mesh 54b separates the first side 78 and the second side 80 and may neutralize potential charge transfer that may otherwise occur as a result of the contact of the top panel 14c2 with the charge contacts 72. Further, both of the mesh panels 52b, 54b may include an endothermic flame retardant material (FIG. 4). For example, the endothermic flame retardant material 44 (FIG. 4) may include, but is not limited to, magnesium hydroxide and calcium sulfate. The endothermic flame retardant material 44 (FIG. 4) may be bonded to the mesh panel 28b.

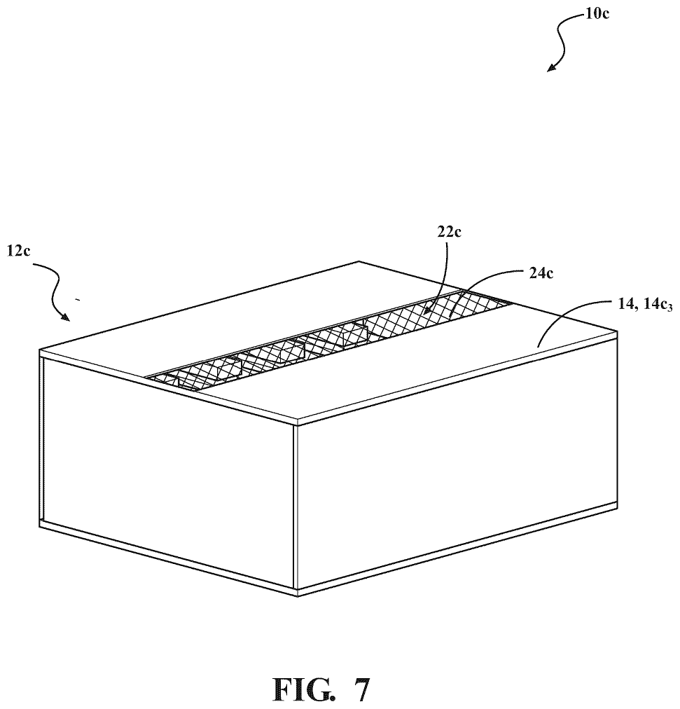

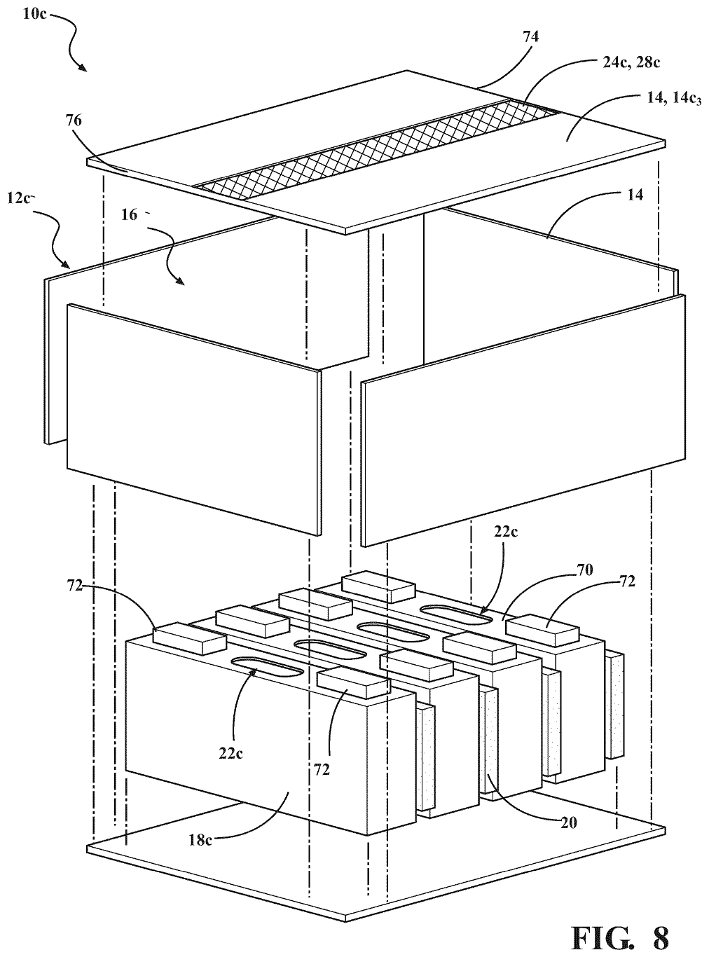

Referring to FIGS. 7 and 8, a battery cell group assembly 10c includes a housing 12c that includes a plurality of panels 14 and battery cells 18c stored within a cavity 16 of the housing 12c. The battery cells 18c are separated by thermal barriers 20 and each define a vent 22c along a first surface 70 of the battery cell 18c. The first surface 70 also includes charge contacts 72 on opposing ends of the first surface 70. The vents 22c may be defined between the charge contacts 72 along the first surface 70. The battery cells 18c are disposed within the housing 12c, and a top panel 14c3 of the plurality of panels 14 may be disposed on the charge contacts 72. In other configurations, the top panel 14c3 may be disposed on sidewalls of the plurality of panels 14 and spaced apart from the charge contacts 72.

The top panel 14c3 may also define a vent 22c that extends between a first end 74 and a second end 76 of the top panel 14c3. The vent 22c of the top panel 14c3 includes a flame arrestor 24c extending from the first end 74 to the second end 76. For example, the flame arrestor 24c may be integrally formed with the top panel 14c3. During formation of the top plate 14c3, the mesh panel 28c may be stamped, laser cut, and/or cut via electrical discharge machining from the top plate 14c3 and subsequently coated with an endothermic flame retardant material. For example, the endothermic flame retardant material may include, but is not limited to, magnesium hydroxide and calcium sulfate.

The flame arrestor 24c is configured to cover or otherwise be disposed over the vents 22c defined by the battery cells 18c. The flame arrestor 24c may include a mesh panel 28c that may include a first set of the openings 30 (FIG. 4) and a second set of openings 50 (FIG. 4). The first set of openings 30 may be smaller than the second set of openings 50. For example, the battery cells 18c may eject particulate matter, and the first, smaller set of openings 30 are configured to prevent the ejected particulate matter from escaping the housing 12c, while the second, larger openings 50 maintain the airflow between the cavity 16 and the external environment. The mesh panel 28c traps the particulate matter within the cavity 16 of the housing 12c. The second set of openings 50 are configured to direct the airflow between the external environment and the cavity 16. Thus, the second set of openings 50 are configured to be larger than the first set of openings 30.

Referring to FIGS. 1-8, the battery cell group assembly 10-10c is configured with the flame arrestor 24-24c to redirect heat generated by the battery cells 18-18c and to minimize the potential for a thermal runaway event of the battery cell group assembly 10-10c. The mesh panel 28-28c of the flame arrestor 24-24c provides openings 30, 50 through which the airflow may pass to minimize condensation while redirecting heat generated by the battery cells 18-18c. The endothermic flame retardant material of the mesh panel 28-28c assists in redistributing the heat at the flame arrestor 24-24c across the thermally conductive surface area 26. Thus, the flame arrestor 24-24c is configured to redirect or shunt heat to the thermal mass 32, while the mesh panel 28-28c remains cool, such that the flame arrestor 24-24c rapidly cools hot gasses venting from the battery cells 18-18c.

The mesh panel 28-28c is configured with a surface area large enough to absorb heat from the gas vented from the battery cells 18-18c. For example, the heated gas emitted by the battery cells 18-18c passes through the mesh panel 28-28c, and the heat is redirected from the gas along the thermally conductive surface area 26 of the flame arrestor 24-24c. The mesh panel 28-28c is designed to have sufficiently low resistance relative to other potential gaps or openings in the housing 12-12c, such that the heated gas passes through the mesh panel 28-28c when traveling a path of least resistance. Further, the varied size of the openings 30, 50 assists in capturing any potential particulate matter ejected by the battery cells 18-18c, which prevents the particulate matter from circulating within an engine system of the vehicle 100.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A battery cell group assembly for a vehicle, the battery cell group assembly comprising:
a housing including a plurality of panels defining a cavity;
one or more battery cells disposed within the cavity of the housing;
one or more thermal barriers coupled to each of the one or more battery cells;
one or more vents defined proximate to the one or more battery cells;
at least one flame arrestor disposed over the one or more vents, the at least one flame arrestor having a thermally conductive surface area and including a first set of openings configured to redirect heat from the one or more battery cells within the cavity of the housing; and
a thermal mass thermally coupled to the at least one flame arrestor.

2. The battery cell group assembly of claim 1, wherein the at least one flame arrestor includes a mesh panel that includes an endothermic flame retardant material.

3. The battery cell group assembly of claim 1, wherein the thermal mass is a cooling system and the at least one flame arrestor is integrally formed with the cooling system.

4. The battery cell group assembly of claim 1, wherein vents of the one or more vents are defined by the battery cells and the at least one flame arrestor is integrally formed with each battery cell at a respective vent.

5. The battery cell group assembly of claim 1, wherein the one or more vents are defined by the battery cells and the at least one flame arrestor is integrally formed with a top panel of the plurality of panels of the housing.

6. The battery cell group assembly of claim 2, wherein the battery cells include particulate matter and the mesh panel of the at least one flame arrestor is configured to trap the particulate matter within the cavity of the housing.

7. The battery cell group assembly of claim 6, wherein the mesh panel includes a first mesh and a second mesh, the first mesh including the first set of openings, the first set of openings being smaller than a second set of openings of the second mesh.

8. A battery cell group assembly comprising:
a housing including a plurality of panels defining a cavity;
one or more battery cells disposed within the cavity of the housing;
vents defined proximate to the one or more battery cells;
at least one flame arrestor disposed over the vents, the at least one flame arrestor having a thermally conductive surface area and including a mesh panel, the mesh panel including a first set of openings configured to redirect heat from the one or more battery cells within the cavity of the housing; and
a thermal mass thermally coupled to the at least one flame arrestor.

9. The battery cell group assembly of claim 8, wherein the mesh panel of the at least one flame arrestor includes an endothermic flame retardant material.

10. The battery cell group assembly of claim 8, wherein the thermal mass is a cooling system and the at least one flame arrestor is integrally formed with the cooling system.

11. The battery cell group assembly of claim 8, wherein the vents are defined by the battery cells and the at least one flame arrestor is integrally formed with each battery cell at a respective vent.

12. The battery cell group assembly of claim 8, wherein the vents are defined by the battery cells and the at least one flame arrestor is integrally formed with a top panel of the plurality of panels of the housing.

13. The battery cell group assembly of claim 8, wherein the battery cells include particulate matter and the mesh panel of the at least one flame arrestor is configured to trap the particulate matter within the cavity of the housing.

14. The battery cell group assembly of claim 13, wherein the mesh panel includes a first mesh and a second mesh, the first mesh including the first set of openings, the first set of openings being smaller than a second set of openings of the second mesh.

15. A battery cell group assembly for a vehicle, the battery cell group assembly comprising:
a housing including a plurality of panels defining a cavity;
one or more battery cells disposed within the cavity of the housing;
vents defined proximate to the one or more battery cells;
at least one flame arrestor disposed over the vents, the at least one flame arrestor having a thermally conductive surface area and including a mesh panel, the mesh panel including a first set of openings configured to redirect heat from the one or more battery cells within the cavity of the housing and including an endothermic flame retardant material; and
a thermal mass thermally coupled to the at least one flame arrestor.

16. The battery cell group assembly of claim 15, wherein the thermal mass is a cooling system and the at least one flame arrestor is integrally formed with the cooling system.

17. The battery cell group assembly of claim 15, wherein the vents are defined by the battery cells and the at least one flame arrestor is integrally formed with each battery cell at a respective vent.

18. The battery cell group assembly of claim 15, wherein the vents are defined by the battery cells and the at least one flame arrestor is integrally formed with a top panel of the plurality of panels of the housing.

19. The battery cell group assembly of claim 15, wherein the battery cells include particulate matter and the mesh panel of the at least one flame arrestor is configured to trap the particulate matter within the cavity of the housing.

20. The battery cell group assembly of claim 19, wherein the mesh panel includes a first mesh and a second mesh, the first mesh including the first set of openings, the first set of openings being smaller than a second set of openings of the second mesh.
